(19) United States
(12) Patent Application Publication
(10) Pub. No.: US 2008/0162539 A1
(43) Pub. Date: Jul. 3, 2008

(54) Dynamic cockpit creator

(75) Inventors: Wolfgang E. Walter, Hambruecken (DE); Amar Kumar, Neulussheim (DE)

Correspondence Address: SAP/BLAKELY, 1279 OAKMEAD PARKWAY, SUNNYVALE, CA, 94085-4040, US

(73) Assignee: SAP AG

(21) Appl. No.: 11/648,343

(22) Filed: Dec. 28, 2006

(51) Int. Cl. G06F 17/30

(52) U.S. Cl. 707/102

(57) ABSTRACT

Parameters in a database control the screen configuration and data to be displayed through a user interface. One such interface can be used to configure other similarly-constituted user interfaces. One interface can be incorporated as a sub-element of another interface in a hierarchical fashion.

### FIELD

The invention relates to computer user interfaces. More specifically, the invention relates to database-centric methods for creating and operating customized user interfaces.

### BACKGROUND

Commercially-available databases are often designed to store arbitrary types and quantities of data, so that a single, flexible database engine can be used in many different applications. However, even within a relatively narrow field of endeavor (e.g. supply chain management or medical practice accounting), two different database users may have different requirements for effective integration of the database into their business operations. Such requirements are traditionally satisfied through database customization, where an engineer configures database operational parameters and writes software to adapt the database's capabilities to the business's needs.

Database customization can be expensive and time-consuming, and sometimes requires special training and experience to perform correctly. Therefore, some businesses must make do with a generic configuration and functionality, or with a system that has become outdated with respect to the business's present needs. Database systems and methods that can be configured and customized more flexibly (and by users with less special training) may be valuable to the businesses that use them.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a sample user interface screen implemented using an embodiment of the invention.

FIG. 2 is a flow chart outlining a method followed by an embodiment.

FIG. 3 is a flow chart outlining an extension to an embodiment of the invention.

FIG. 4 is a flow chart illustrating an alternate embodiment.

FIG. 5 shows a number of elements that may be available for use in a dynamic cockpit.

FIG. 6 shows some subsystems of a computer system that implements an embodiment.

### DETAILED DESCRIPTION

Embodiments of the invention store information to describe a user interface for a database within the database itself. Some embodiments are “recursive” in the sense that a user interface for manipulating the user-interface information in the database can itself be described by information in the database. In some embodiments, a first user interface incorporating several elements (as described below) can be incorporated as an element within a portion of a second user interface. Thus, complex interfaces can be built up of a hierarchy of interface modules.

A user interface may display relevant information and/or provide controls to help a user do his job. In this respect, it is like the instruments and controls in the cockpit of an airplane. The term “cockpit” will be used herein to denote a grouping of information displays and controls that are useful to accomplish or monitor a task. Some cockpits may display information only, while others may offer controls only (without displaying feedback information).

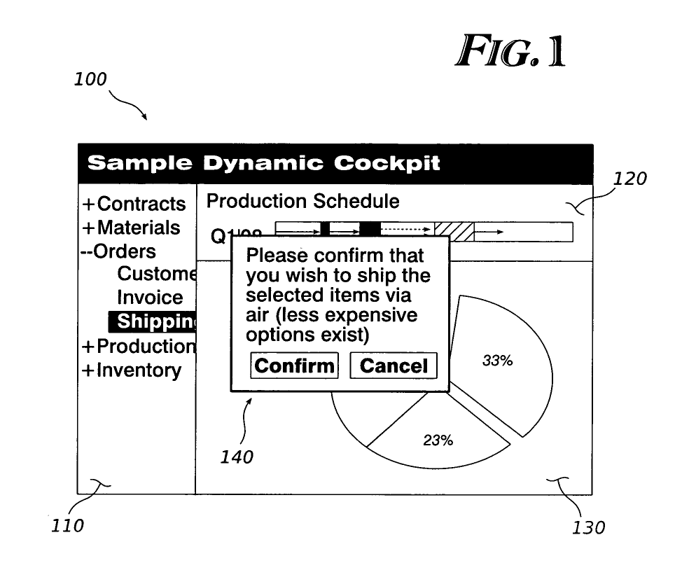

FIG. 1 shows a sample cockpit implemented using an embodiment of the invention. The cockpit's visual appearance will be familiar to users of contemporary computing systems. The operations of embodiments of the invention that produce the user interface display will be discussed below.

The sample user interface shown here is presented on a display screen 100, which may be connected directly or via a distributed data network to a computing system (not shown). The screen is divided into several areas 110, 120, 130 called “panels” or “panes.” Panes may be tiled (non-overlapping), as shown by panes 110, 120 and 130; or may occlude one another in a simulated stacking arrangement. Embodiments of the invention permit a user to configure pane number, size, and layout flexibly. Panes can be subdivided into two or more horizontal or vertical sub-panes, and sub-panes can similarly be subdivided. “Pop-up” window 140 is an example of a stacked window: it obscures some of the material displayed in tiled panes 120 and 130. Pop-up windows are often used to present information that the user must examine and acknowledge before the system can continue its operations. A “modal” window may prevent the user from continuing until he provides required information or approves an action. Non-modal windows may also be supported, and may useful to provide notes, reminders, or other auxiliary information without interrupting system operations.

A user can interact with the cockpit elements using some or all of a keyboard, mouse, pressure-sensitive tablet, voice recognition system, or other input devices.

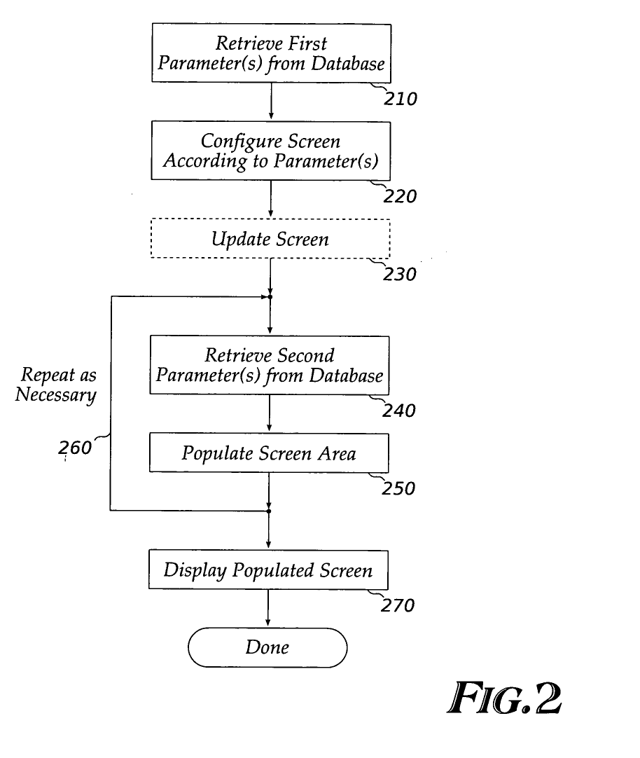

FIG. 2 outlines a method followed by an embodiment of the invention to produce a cockpit such as that shown in FIG. 1. One or more parameters are retrieved from the database (210). These parameters describe the screen configuration: how (or whether) the display area is to be divided into panes, what is to be displayed in each pane, and so on. The screen configuration indicated by the parameter is set (220). In some embodiments, the screen is updated at this point (230), so one or more blank panes may be displayed. In other embodiments, the screen configuration is modeled only within the memory of a computer system, and displayed after it has been completely configured and populated.

Next a second parameter (or set of parameters) is retrieved from the database (240). The second parameter(s) describe a data source, cockpit control, or other element to be displayed within an area of the screen. A data source may be, for example, a value or table in the database, an external source such as a web service, or a static image or text block. Appropriate information is retrieved from the data source and the area of the screen is populated with this information (250).

If the screen configuration contains multiple areas to be populated with information or controls, the previous operations are repeated as necessary (260). Finally, the configured, populated screen is displayed to the user (270).

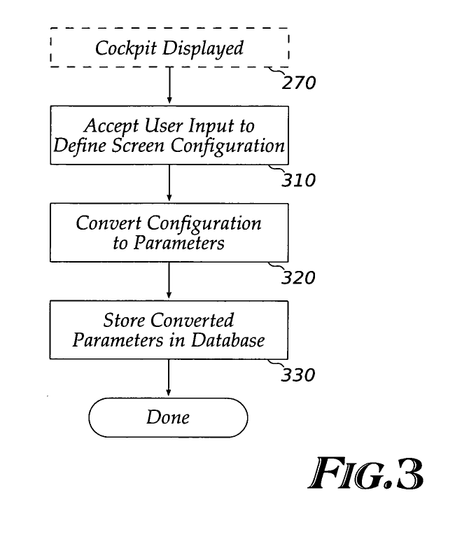

It is appreciated that, in the foregoing method, the data source for a portion of the screen could refer to the parameter(s) that describe a screen configuration. Thus, as mentioned above, an embodiment of the invention can be used to produce a cockpit for examining and controlling another cockpit. In other words, an embodiment can implement a first cockpit to be used to create or modify a second cockpit. This mode of operation is outlined in the flow chart of FIG. 3, which further refines the process described in reference to FIG. 2. Once a cockpit is displayed, an embodiment accepts user input to define a screen configuration (310) and converts the screen configuration into the one or more parameters retrieved at 210 (320). Finally, the converted parameters are stored (330) so that a subsequent invocation of an embodiment can reproduce the screen configuration. The parameters may be stored in any convenient format. For some embodiments, a text-based format may be useful, as it may permit direct user editing and may be transmitted easily via electronic mail. One text-based format that may be particularly useful is the Extensible Markup Language (“XML”). XML can be readily parsed and operated on by automatic logic to produce a dynamic cockpit.

It is also appreciated that the data source, cockpit control, or other element to be displayed within an area of the screen could itself be a cockpit, with its own screen configuration to divide the screen area allocated to it, and its own set of data sources, cockpit controls or other elements to be displayed. There is no theoretical limit to the level of such nesting, although the repeated subdivision of a finite screen area might quickly render a cockpit displayed in a subscreen unusably small. Some embodiments may address this issue by implementing a “zoom” function to permit the user to expand a subscreen to fill the entire screen. A complementary function would permit the expanded subscreen to be returned to its previous size, restoring any other previously-displayed subscreens. Note that XML is a hierarchical markup language, so it may be well-suited to representing nested cockpit hierarchies.

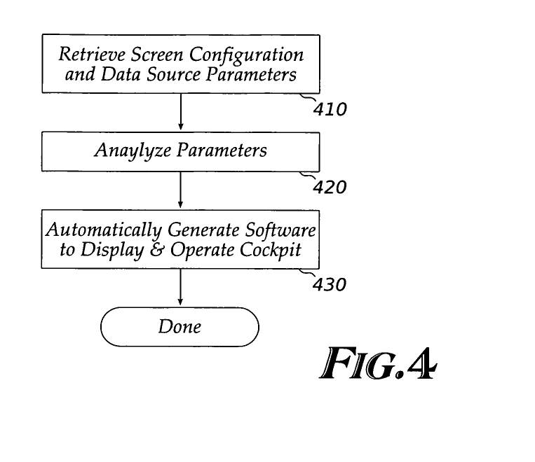

Some embodiments of the invention implement the screen configuration and data source population directly, while others may build on legacy database customization infrastructure as indicated in FIG. 4. Some databases offer an Application Program Interface (“API”) including libraries of instructions and data to permit a program to interact with the database. An embodiment of the invention can retrieve the screen configuration and data source parameters from the database (410), much as they were in the method of FIG. 2. Now, however, the parameters are analyzed (420) and software (a set of instructions and data) is automatically generated (430). These instructions and data are operable to cause a programmable processor to perform the other operations discussed in FIG. 2. Some embodiments may emit these instructions and data in a “source code” form that must be further processed (e.g. by compiling and linking) to create executable instructions, while other embodiments may produce the executable instructions directly.

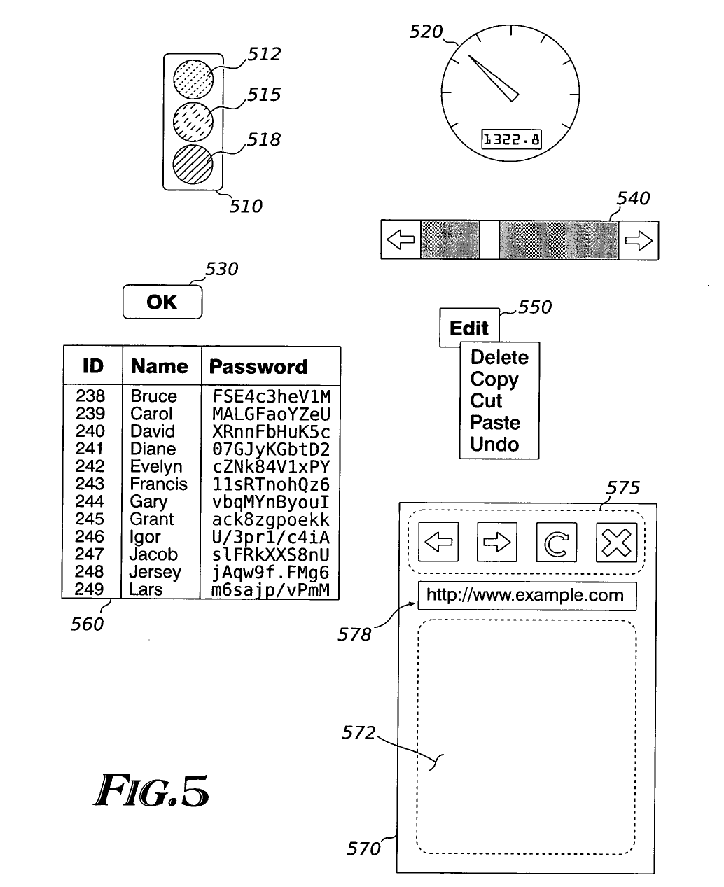

FIG. 5 shows several objects that may be displayed in a cockpit configured according to an embodiment of the invention. Element 510 is an informative graphic icon that resembles a traffic signal. Colors (red 512, yellow 515 and green 518) are used to indicate the status of an underlying process. Element 520 is another informative graphic icon that is modeled after an analog meter. This icon may be placed in a pane of a cockpit to monitor a process value or status. Cockpit components that monitor dynamically-changing data or processes may be associated with an update timer that refreshes the component periodically, after receiving a notification that the monitored data has changed, or in response to a “redraw” signal from the user or from user interface management software.

Element 530 is a button that can be added to a cockpit to accept input from a user. Other common computer user-interface elements such as scroll bar 540 and menu 550 can also be used.

Element 560 is a simple database table browser that can produce a tabular display of data stored in the database (and, in some embodiments, accept changes to the data or new records).

Although most of the elements described above are relatively simple, cockpits may also contain large, sophisticated objects. Element 570 is a Hypertext Markup Language (“HTML”) browser that can retrieve text and graphics from a network data source and render them within a display area 572. An HTML browser component may have its own user interface controls such as buttons 575 and Uniform Resource Locator (“URL”) entry field 578. Some embodiments of the invention permit the cockpit designer to adjust parameters controlling the display of an HTML browser component 570, so that buttons 575 and/or URL entry field 578 are not displayed.

In addition, as mentioned several times, a cockpit can contain other cockpits. Some embodiments may provide features to facilitate this. For example, a generic “analog control” cockpit containing a meter icon 520 and a numeric entry field (not shown) could be added to a cockpit and configured to monitor and control a particular numeric database field. The same generic analog control cockpit could be part of several different cockpits, or multiple copies of the analog control could be included in the various subscreens of a single cockpit.

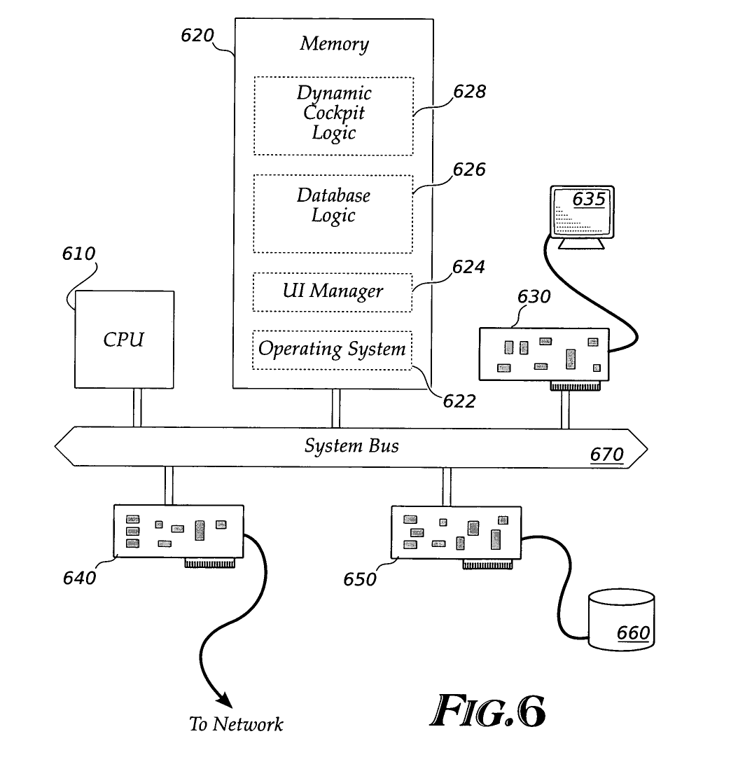

FIG. 6 shows a system that can support an embodiment of the invention. Central processing unit (“CPU”) 610 is a programmable processor that executes instructions stored in memory 620. These instructions can be broken up into various subsystems such as operating system 622 to control the system's hardware devices, allocate resources and perform various timekeeping functions, user interface (“UI”) manager 624 to present information on a graphical display 635 (signals for the display are produced by video adapter 630), database logic 626 to store and retrieve data on mass storage device 660, and dynamic cockpit logic 628 to implement methods as described above. A network interface 640 can be used to communicate with other cooperating systems via a distributed data network such as the Internet. The various components of the system exchange data and commands via system bus 670.

An embodiment of the invention may be a machine-readable medium having stored thereon instructions which cause a programmable processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROM), Read-Only Memory (ROM), Random Access Memory (RAM), and Erasable Programmable Read-Only Memory (EPROM).

The applications of the present invention have been described largely by reference to specific examples and in terms of particular allocations of functionality to certain hardware and/or software components. However, those of skill in the art will recognize that database cockpit design and operation can also be achieved by software and hardware that distribute the functions of embodiments of this invention differently than herein described. Such variations and implementations are understood to be captured according to the following claims.

We claim:

1. A method comprising:
retrieving a first parameter from a database, the first parameter to describe a screen configuration;
retrieving a second parameter from the database, the second parameter to describe a data source;
displaying the screen configuration described by the first parameter; and
populating a portion of the screen configuration with data from the data source.

2. The method of claim 1, further comprising:
accepting user input to define a screen configuration;
converting the user input to the first parameter; and
storing the first parameter in the database.

3. The method of claim 1, further comprising:
accepting user input to identify a data source and a presentation style;
converting the user input to the second parameter; and
storing the second parameter in the database.

4. The method of claim 1, further comprising:
automatically generating instructions and data to control a programmable processor, wherein the instructions and data are to cause the programmable processor to perform the displaying and populating operations.

5. The method of claim 1 wherein the data source is a table in the database.

6. The method of claim 1 wherein the data source is a web service.

7. A computer-readable medium containing instructions to cause a programmable processor to perform operations comprising:
retrieving information from a database, the information to describe a hierarchical display configuration and a content of the hierarchical display configuration;
presenting the hierarchical display configuration in a portion of a display screen; and
populating the hierarchical display configuration with the content.

8. The computer-readable medium of claim 7 wherein the portion of the display screen is described by a second hierarchical display configuration, and
the second hierarchical display configuration is described by information in the database.

9. The computer-readable medium of claim 7, containing additional instructions to cause the programmable processor to perform operations comprising:
presenting a user interface to collect hierarchical display configuration information from a user; and
storing the hierarchical display configuration information in the database.

10. The computer-readable medium of claim 7, containing additional instructions to cause the programmable processor to perform operations comprising:
generating instructions and data from the information, the instructions and data to cause the programmable processor to perform the presenting and populating operations.

11. The computer-readable medium of claim 7 wherein the information is stored in a text-based format.

12. The computer-readable medium of claim 11 wherein the text-based format is Extensible Markup Language (“XML”).

13. The computer-readable medium of claim 7 wherein the content includes information from the database.

14. The computer-readable medium of claim 7 wherein the content includes information from a web service.

15. The computer-readable medium of claim 7, containing additional instructions to cause the programmable processor to perform operations comprising:
automatically refreshing the content after a predetermined event.

16. A system comprising:
a database to store screen layout information and operational information;
a graphical display; and
dynamic cockpit logic to retrieve the operational information and display it on the graphical display according to the screen layout information.

17. The system of claim 16 wherein the screen layout information comprises a plurality of hierarchical cockpit definitions, and
one cockpit is to be displayed within a portion of another cockpit.

18. The system of claim 16, further comprising:
update logic to refresh the graphical display after a predetermined event.

19. The system of claim 18 wherein the predetermined event is one of an expiration of a predetermined period of time, a change of the operational information, or a refresh request from a user.
